(19) United States
(12) Patent Application Publication
(10) Pub. No.: US 2015/0379409 A1
(43) Pub. Date: Dec. 31, 2015

(54) COMPUTING APPARATUS AND METHOD FOR MANAGING A GRAPH DATABASE

(71) Applicant: FUJITSU LIMITED, Kawasaki (JP)

(72) Inventors: Bo HU, Winchester (GB); Roger MENDAY, Guildford Surrey (GB)

(73) Assignee: FUJITSU LIMITED, Kawasaki (JP)

(21) Appl. No.: 14/703,236

(22) Filed: May 4, 2015

(30) Foreign Application Priority Data
Jun. 30, 2014 (EP) 14175097.6

(51) Int. Cl. G06N 5/04; G06F 17/30; G06N 5/02

(52) U.S. Cl. CPC G06N 5/04; G06N 5/022; G06F 17/30247

(57) ABSTRACT

Embodiments include an apparatus to automate integration of non-conceptual data items into a data graph, the graph including graph nodes and graph edges, the computing apparatus comprising: a data storage system configured to store, as a node, a behavior handler to update the data graph in response to an occurrence of a specified trigger event, the node representing the behavior handler being stored in association with the non-conceptual data item; an execution module configured to execute the procedure defined by a behavior handler in response to the event; a modification identification module to identify modified graph elements, and to record the graph elements as modifications attributed to the behavior handler; an inference module configured to infer relationships between behavior handlers by, analyzing the modifications attributed to the behavior handlers to identify relationships between the modifications, and adding the relationships to the data graph as edges between the graph nodes.

### CROSS-REFERENCE TO RELATED APPLICATIONS

This application claims the benefit of European Application No. 14175097.6, filed Jun. 20, 2014, in the European Intellectual Property Office, the disclosure of which is incorporated herein by reference.

### BACKGROUND

1. Field

The present invention lies in the field of data storage and, in particular, relates to a mechanism for storing data in a semantically meaningful way.

2. Description of the Related Art

Relational databases store data in rows and columns. The rows and columns compose tables that need to be defined before storing the data. The definition of the tables and the relationship between data contained on these tables is called a schema. A relational database uses a fixed schema. Graph databases represent a significant extension over relational databases by storing data in the form of nodes and arcs, where a node represents an entity or instance, and an arc represents a relationship of some type between any two nodes. In an undirected graph, an arc from node A to node B is considered to be the same as an arc from node B to node A. In a directed graph, the two directions are treated as distinct arcs.

Graph databases are used in a wide variety of different applications that can be generally categorized into two major types. The first type consists of complex knowledge-based systems that have large collections of class descriptions (referred to as “knowledge-based applications”), such as intelligent decision support and self learning. The second type includes applications that involve performing graph searches over transactional data (referred to as “transactional data applications”), such as social data and business intelligence. Many applications may represent both types. However, most applications can be characterized primarily as either knowledge-based or transactional data applications. Graph databases can be used to maintain large “semantic networks” that can store large amounts of structured and unstructured data in various fields. A semantic network is used as a form of knowledge representation and is a directed graph consisting of nodes that represent concepts, and arcs that represent semantic relationships between the concepts.

Ontological approaches to knowledge representation and reasoning and knowledge management may be required to effectively combine conceptual knowledge, which is visible to any ontology inference engine, and non-conceptual (or the so-called “concrete”) knowledge (numeric, literal or other types of data), which is not visible or not transparent to existing ontology inference engines. The latter includes string, numeric data and multimedia data.

Currently, design time approaches exist in which a knowledge engineer must manually add semantic information to non-conceptual data at design time. Incorporating non-conceptual into the semantic network at design time results in significant overhead to the knowledge engineer and presents the potential for modeling discrepancies, partially due to human errors and human idiosyncrasies. The quality of overall inference, therefore, cannot be guaranteed. Design time approach also requires the knowledge engineers to have good knowledge of both conceptual and non-conceptual data which might not be easy to acquire and might not be easy to integrate.

Using dedicated tools for managing and handling non-conceptual data separated from conceptual ones removes the extra requirements imposed by the design-time approach. However, such dedicated tools need to be wrapped so as to make the reasoning results visible to those engines designed for the conceptual data. Errors and/or inconsistency might be introduced at the “wrapping” stage. Ontological inference is normally based on open-world assumptions, which is not necessarily fully compatible with tools for handling non-conceptual knowledge, which are normally based on closed world assumptions. Furthermore, the semantics associated with non-conceptual data are not necessarily clearly and uniformly defined and thus are not easily understood by human knowledge engineers (e.g. for quality assurance purposes).

The integral inference of semantic information describing both conceptual and non-conceptual data is not straightforward, due to the invisibility of each one in the management system of the other. In existing technologies, non-conceptual data is made available through arbitrarily created conceptual entities representing a subset of the former. For instance, the numeric value of people's age can be introduced as either a point value or a range value associated with an arbitrary “age” object. This object may then be connected to the person instance as illustrated in FIG. 1. FIG. 1 illustrates examples of exploiting concrete knowledge. On the right hand side, the point value of Mr X's age (35) is an implementation of the concept “Mr X's Age”, and is not visible to ontological inference engines and ontology management systems and thus is not considered in ontology reasoning. A specialized functional tool, whose outcomes are reflected through arbitrary modeling in the conceptual part, is required in order to attribute semantic information to the point value of Mr X's age.

### SUMMARY

Additional aspects and/or advantages will be set forth in part in the description which follows and, in part, will be apparent from the description, or may be learned by practice of the invention.

Embodiments of the present invention include a computing apparatus configured to automate the integration of non-conceptual data items into a data graph, the data graph being composed of graph elements including graph nodes and graph edges, the computing apparatus comprising: a data storage system configured to store, as a graph node of the data graph for each of a plurality of non-conceptual data items, a behavior handler defining a procedure for using the non-conceptual data item to update the data graph in response to an occurrence of a specified trigger event, the graph node representing the behavior handler being stored in association with the non-conceptual data item; an execution module configured to execute the procedure defined by a behavior handler from among the behavior handlers in response to an occurrence of the specified trigger event for the behavior handler; a modification identification module configured to identify graph elements modified as a consequence of the execution of the procedure, and to record the identified graph elements as members of a set of modifications attributed to the behavior handler defining the executed procedure; an inference module configured to infer relationships between behavior handlers by, for each pair of behavior handlers defining executed procedures, analyzing the sets of modifications attributed to the pair of behavior handlers in order to identify relationships between the sets of modifications, and adding the identified relationships to the data graph as edges between the graph nodes representing the respective behavior handlers.

Advantageously, the procedure followed by embodiments enables the semantics of both conceptual knowledge, being knowledge represented in the data graph, and non-conceptual knowledge, being knowledge represented by non-conceptual data items linked to surrogate entities in the data graph, to be unified and described in a single ontology.

The linking (storing in association) of non-conceptual data items to behavior handler graph nodes in the data graph provides a mechanism for attributing semantic information to the non-conceptual data items, and the analysis of the activity of the behavior handlers (the sets of modifications attributed to the behavior handlers) provides a mechanism for determining what that semantic information should be. Thereby, the inference effort involved in handling heterogeneous data containing both conceptual and non-conceptual entities is simplified and reduced.

In providing a tool for the integration of non-conceptual data into a conceptual data graph, embodiments enrich the expressiveness of knowledge representation and reasoning formalisms enabled by the data graph. Furthermore, the procedure according to invention embodiments is systematic and therefore reduces modeling variations which can result from a lack of automated methodology in modeling non-conceptual data.

The procedure is automated in that it proceeds in the absence of user input at runtime.

Non-conceptual data items may also be referred to as concrete data items and may be defined as data from an XML schema or from an XML schema type system. Non-conceptual data items are data that cannot be modeled directly with the native constructs of an ontology modeling language. Non-conceptual data items may be native data types from imperative programming languages. For example, in Java the Integer, String, Double, etc. Non-conceptual data items may be defined as data items which manifest or implement the resources modeled in the data graph in machine readable or executable form.

The data graph, on the other hand, is a representation of a semantic data model in which resources or entities of the data model are stored as graph nodes (which can also be referred to as vertices), and relationships among those resources or entities are stored as edges (which can also be referred to as arcs or interconnections). In this document, graph entities are used as a collective term for graph nodes and graph edges. The encoding of graph entities (for example, as RDF triples) may be such that graph nodes and graph edges cannot be resolved into separate data items and a graph node is a sum of all of the graph edges relating to the same resource. The data graph models conceptual data, that is, data that can be modeled with a non-extended ontology modeling language such as OWL or RDF or RDFS. Such modeling languages focus on capturing the entities in the domain being modeled and capturing the relationships among the entities. Reasoning based on such languages may be facilitated through a subset of first order predicate logic. For instance, OWL is supported by description logic satisfaction problem.

The data graph is effectively a manifestation of stored data, and is a means for representing the stored data, both to a user and to event handlers or other processes internal to the data storage system. It may be that the data graph is encoded as triples, for example, RDF triples, and that a resource is defined by the triples in which it is named as the subject. Alternatively or additionally, it may be that data is stored in a key value store, with triples serving as keys indexing storage locations at which additional data (for example, metadata) defining a resource is stored.

Triples provide for encoding of graph data by characterizing the graph data as a plurality of subject-predicate-object expressions. In that context, the subject and object are graph nodes of the graph data, and the predicate is a representation of a relationship between the subject and the object. The predicate asserts something about the subject by providing a specified type of link to the object. For example, the subject may denote a Web resource (for example, via a URI), the predicate denote a particular trait, characteristic, or aspect of the resource, and the object denotes an instance of that trait, characteristic, or aspect. In other words, a collection of triple statements intrinsically represents directional graph data. The RDF standard provides formalized structure for such triples.

Graph edges are labeled relationships between graph nodes. The edges may be directional. An edge from a first graph node to a second graph node denotes or defines a logical connection between the two graph nodes, with the label assigned to the edge defining the form of that logical relationship. For example, the first graph node may be considered to be a subject and the second graph node an object. The label of the edge identifies a property of the subject, and the value of the object defines a range or value of that property attributable to the subject. Predicate is a term that may be used to define the label assigned to the edge.

A behavior handler, which may also be referred to an event handler, provides a mechanism for an occurrence of a particular type of event, for example, a write access changing a data value included in a graph element, to cause processing to be performed beyond that involved in the occurrence itself. The inclusion of behavior handlers in the data graph provides the functionality for a single occurrence of an event to cause a series of consequential processing events, the behavior handlers defining rules and/or instructions for determining what those consequential processing events are and for executing them.

A behavior handler may be a process or a set of instructions which, when executed by a processor, cause a process to be performed. A behavior handler being executed may include read or write accesses being made to the data graph and modifications being made. The processing may include modifying stored data, and/or considering whether or not to modify stored data based upon factors which may include characteristics of the processing event giving rise to the execution. Behavior handlers may be stored explicitly in the data graph or may be represented by a link to a storage location at which the processing rules and/or instructions implementing the behavior handler are stored.

The specified trigger event in response to an occurrence of which the behavior handler is executed may be one of a set of trigger events registered to the behavior handler so that the behavior handler is configured to execute a procedure in response to an occurrence of any of the set of trigger events registered thereto. The one or more trigger events in response to an occurrence of which the behavior handler is executed may be defined in terms of an event type (graph entity delete/read/write/update) and/or an event location (location being a specified entity or group of graph entities). The behavior handler may therefore be configured to observe the data graph in order to recognize when a specified event has occurred. Alternatively, the trigger event may be a system event such as a refresh or update, or some other form of data graph-wide processing event or update. The specified trigger event may be an event which makes a read or write access to the non-conceptual data item with which the behavior handler is associated.

The association between the behavior handler and non-conceptual data item used by the behavior handler to update the data graph may be stored in the form of an explicit link having the form of a graph edge or node. However, the non-conceptual data item cannot be interpreted by an inference system configured to handle conceptual data. That is to say, the non-conceptual data items are isolated from the native semantic explication mechanisms of ontology modeling languages. The behavior handler with which it is associated, and specifically the set of modifications attributed thereto, provides a basis for a set of inference rules to determine semantic information about the non-conceptual data item, and to attribute them to the graph node representing the behavior handler.

The behavior handler using a non-conceptual data item to update the data graph may include reading one or more data values from the non-conceptual data item and writing the one or more data values to new or existing graph elements within the data graph, or using the one or more data values to compute values which are written to the data graph. The graph elements which are updated by the behavior handler may be linked to the graph node representing the behavior handler by graph edges. The non-conceptual data item is stored in association with the behavior handler and hence the graph node representing the behavior handler serves as a conduit for graph nodes to access the non-conceptual data item.

The modification identification module is configured to identify graph elements modified as a consequence of the execution of the procedure defined by a behavior handler. Graph elements modified as a consequence of the execution of the procedure may comprise those graph elements accessed and updated by the procedure itself, and may also comprise graph elements modified by other behavior handlers which were triggered by updates performed by the procedure. The behavior handlers themselves (via the execution module) may maintain a register or log of updates which are attributed to the procedure, and/or a graph edit distance algorithm may be used to identify changes in a particular region of the data graph. The record may comprise, in addition to identifying modified graph elements, one or more of the following: an indication of the form of the modification, a time stamp at which the modification took place, an indication of the behavior handler or other entity responsible for performing the modification.

The set of modifications attributed to a behavior handler forms the basis of analysis performed by the inference module. The respective sets of modifications of any pair of behavior handlers can be compared and pattern matching or other forms of analysis applied in order to identify relationships between the sets of modifications, which relationships are added to the data graph as edges between the graph nodes representing the respective behavior handlers. The analysis may include applying a set of rules or other instructions to the sets in order to recognize or identify when certain logical relationships exist between the two sets (i.e. the members of a first set are always instances of a second set, or the members of a first set are always n levels above members of the second set in a hierarchical structure).

In a particular example, the relationships between behavior handlers that the inference module is configured to infer comprise subsumption relationships.

Subsumption relationships are a key building block of a semantic knowledge network, and the ability to store non-conceptual data items in association with subsumption relationships with other entities in a conceptual data graph therefore integrates the non-conceptual data item into the conceptual data graph. Subsumption relationships include parent-child relationships and class-instance relationships. Whether a subsumption relationship exists between two sets of graph elements can be determined by applying rules to the graph nodes among the graph elements if particular rules hold.

Optionally, the inference module is configured to apply rules from a predetermined set of rules to the sets of modifications of each of a pair of behavior handlers in order to identify which relationships from among the predetermined set of relationships exist between the sets of modifications.

For example, the rule applied by the inference module may be, each graph node (which can also be referred to as a vertex) in a first set of modifications is connected to a graph node in a second set of modifications by a graph edge indicating that the graph node from the first set subsumes the graph node from the second set (i.e. the connection is “is-a/instance-of” from the second to the first). If such a rule holds true for all or a predetermined proportion of the first set of modifications, then the inference module may identify that the first set subsumes the second set, and add a connection between the graph nodes representing the behavior handlers to which the respective sets of modifications are attributed indicating the identified relationship.

Optionally, the modification identification module is configured to store the set of modifications attributed to each of the behavior handlers and, each time the procedure defined by a behavior handler from among the plurality of behavior handlers is executed and the modified graph elements identified, the identified graph elements are recorded as members of the set of modifications attributed to the behavior handler by replacing the stored set of modifications attributed to the behavior handler by the union of the stored set and the identified graph elements.

The set of modifications resulting from a single execution of a procedure may not reveal the full scope of graph elements which have the potential to be modified by a behavior handler. It may be that the graph elements modified by a procedure are not the same at each execution of the procedure, and depend on factors including the characterization of the trigger event and properties of the particular occurrence of the trigger event leading to the procedure being executed, and on the state of the data graph at the time of execution. For example, if the procedure is configured to set all of a group of graph elements to a particular state, and at the time of a first execution, each member of the group is already in the particular state, then the set of modifications attributed to the procedure after the first execution of the procedure will not reflect the potential of the procedure to influence the graph. However, at the time of a second execution, it may be that one or more members of the group were not already in the particular state, and therefore one or more modifications will be attributed to the behavior handler. As the number of executions increases, the set of modifications will grow to reflect the potential of the procedure to influence the graph. Optionally, the set of modifications may be restricted in its membership, for example to those graph elements modified by the procedure defined by the behavior handler in the n most recent executions or in the past predetermined fixed length of time.

The manner in which the modifications are identified will depend on the particular implementation requirements and, in particular, on the database management system controlling read and write accesses to the stored data graph. Optionally: executing the procedure defined by a behavior handler includes adding a record to a log stored in association with the behavior handler each time a graph element is modified by the procedure; and the modification identification module is configured to identify graph elements modified as a consequence of the execution of the procedure by reading the log stored in association with the behavior handler defining the procedure.

Advantageously, maintaining such a log provides a basis for graph modifications to be identified. Furthermore, the log may include information which could not necessarily be derived by merely observing the state of the graph. For example, the system log may timestamp modifications, and/or indicate the procedure being executed that caused the modification.

As an alternative to utilizing a system log, or optionally in addition to utilizing a system log, the modification identification module may be configured to identify graph elements modified as a consequence of the execution of the procedure by executing graph edit distance algorithm.

A graph edit distance algorithm determines the changes made to the graph to go from a first graph state to a second graph state. The modification identification module may be configured to store a snapshot of the graph or of a sub-graph before and after execution of the procedure, and to compare the two using a graph edit distance algorithm in order to determine the set of modifications attributed to the procedure. The modification identification module may be configured to perform pattern matching or to confine the snapshots to particular regions of the graph in order to determine whether or not modifications can be rightfully considered to be consequences of the procedure. Alternatively, it may be that the modification identification module is aware of the timing at which procedures are executed and is therefore configured to time the snapshots appropriately so that all modifications between two snapshots can be considered to be consequences of a particular procedure. Optionally, additional procedures triggered by consequences of a first procedure, and the modifications to the graph caused by execution of the additional procedures, may be considered to be consequences of the first procedure.

The data graph itself is a semantic network and represents a knowledge domain with graph nodes representing resources or entities in the domain and graph edges representing relationships between those resources or entities. The data graph is a formalism for knowledge representation, that is to say, the data graph represents a real world domain, and therefore is considered conceptual. Optionally, the data graph is a conceptual data graph. This is contrary to the nature of the non-conceptual data items which, whilst attributable to concepts in the data graph and therefore to some extent representing the knowledge domain, the data item itself is significant at the machine level, that is to say, it provides an object for use in an imperative programming language or one or more lines of processing code executable by a machine.

The data graph is a representation of encoded data. That is to say, the data graph is a manifestation of underlying data and provides a basis for visualizing the data, querying the data, and making the data available to user applications. The underlying data and the manner in which they store the data graph will depend upon the specific implementation requirements. Examples include the conceptual data graph being encoded using an ontology modeling language.

The ontology modeling language may be customized for use in an embodiment, or embodiments may also operate with ontology modeling languages which have not been customized or modified from their standardized forms. For example, the resource description framework (RDF) or resource description framework schema (RDFS) could be used, or the ontology modeling language OWL. The encoding determines the form of data items stored by the data storage system as part of the data graph.

Turning now to the non-conceptual data items, they may be in the form of objects ready for utilization by an imperative programming language such as Java, and may be encoded by a schema system. For example, it may be that the non-conceptual data items are encoded by a schema system. An exemplary schema system which could be employed for such a purpose is the XML schema system.

The non-conceptual data items are readable by the procedure defined by a behavior handler, and the non-conceptual data item associated with a behavior handler is utilized during execution of the procedure defined by the behavior handler in order to modify graph elements. The execution of the procedure is triggered by an occurrence of a specified trigger event. The trigger event may be specified on a per behavior handler basis. Each behavior handler may be stored in association with a list of one or more trigger events, occurrences of which cause the procedure defined by the behavior handler to be executed. The trigger event may be an event causing a change to the non-conceptual data item, or an event causing a change to one or more specified graph elements. Alternatively, the trigger event may be a system event.

Optionally, the specified trigger event is either a structural change to a specified sub-graph within the data graph or a modification to the non-conceptual data item.

Thus, the behavior handler defines a procedure which responds to a specified trigger event. The effects of the procedure defined by the behavior handler can therefore be considered to be the response to the trigger event, and since the procedure utilizes the non-conceptual data item, there is a logical link between the trigger event and the non-conceptual data item. The trigger event may even be a modification to the non-conceptual data item.

Data graphs can be of a size which necessitates storage across more than one computing device, or storage server. Furthermore, sub-graphs may be duplicated for reasons of fault tolerance and to improve query handling. Thus, the computing apparatus may be a single computing device such as a server, or may be a plurality of interconnected computing devices such as servers. In particular:

The computing apparatus itself may be a plurality of servers connected via a communication network, each server being configured to store a sub-graph of the data graph. The sub-graphs so stored may or may not be overlapping, depending on the particular implementation requirements. The communication network may be wired or wireless, or a combination of the two. Each server may comprise a data storage unit on which the sub-graph is stored, in addition to components including a CPU, a network interface card, and memory. The servers may interface using a P2P paradigm or in some other manner. The servers may collaborate in order to realize the functionality of the data storage system, the execution module, the modification identification module, and the inference module. Alternatively, there may a single computing device configured to provide the functionality of the execution module, the modification identification module, and the inference module. That single computing device may be a server having a control function. The servers may also be referred to as data storage servers, computing devices, computers, or nodes.

Distributed data storage systems having processing functionality at each server present the opportunity for parallelization of some procedures, which avoids processing bottlenecks and improves fault tolerance. For example, the modification identification module may be realized by each of the servers operating in cooperation with one another. Optionally, the modification identification module comprises a component module on each server configured to identify graph elements stored on the respective server modified as a consequence of the procedure.

Advantageously, dividing the functionality of the modification identification module so that each server checks the sub-graph stored thereon for modifications as a consequence of the procedure being executed reduces the processing burden on any single server, thereby improving response time and reducing processing bottlenecks. Furthermore, it reduces network traffic associated with one server assessing the sub-graph stored on another server.

Embodiments of another aspect include a method for the automated integration of non-conceptual data items into a data graph, the data graph being composed of graph elements including graph nodes and graph edges, the method comprising: for each of a plurality of non-conceptual data items: representing, as a graph node of the data graph, a behavior handler defining a procedure for using the non-conceptual data item to update the data graph in response to an occurrence of a specified trigger event, the graph node representing the behavior handler being stored in association with the non-conceptual data item; executing the procedure defined by the behavior handler in response to an occurrence of the specified trigger event; and identifying graph elements modified as a consequence of the execution of the procedure, and recording the identified graph elements as members of a set of modifications attributed to the behavior handler defining the executed procedure. The method further comprises inferring relationships between behavior handlers by, for each pair of behavior handlers, analyzing the respective sets of modifications in order to identify relationships between the sets of modifications, and adding the identified relationships to the data graph as edges between the graph nodes representing the respective behavior handlers.

For example, such a method may be a computer-implemented method. The method may be implemented using a single computer or server, or a plurality of interconnected computers or servers.

Embodiments of another aspect include a computer program which, when executed by a computing apparatus, causes the computing apparatus to function as a computing apparatus defined above as an invention embodiment.

Embodiments of another aspect include a computer program which, when executed by a computing apparatus, causes the computing apparatus to perform a method defined above or elsewhere in this document as an invention embodiment.

Furthermore, embodiments of the present invention include a computer program or suite of computer programs, which, when executed by a plurality of interconnected computing devices, cause the plurality of interconnected computing devices to perform a method embodying the present invention.

Computing apparatus or devices embodying the present invention may include a memory on which instructions (a computer program) are stored and a processor configured to process data in accordance with the stored instructions.

Embodiments of the present invention also include a computer program or suite of computer programs, which, when executed by a plurality of interconnected computing devices, cause the plurality of interconnected computing devices to function as a computing apparatus defined above or elsewhere in this document as an invention embodiment.

Although the aspects (software/methods/apparatuses) are discussed separately, it should be understood that features and consequences thereof discussed in relation to one aspect are equally applicable to the other aspects. Therefore, where a method feature is discussed, it is taken for granted that the apparatus embodiments include a unit or apparatus configured to perform that feature or provide appropriate functionality, and that programs are configured to cause a computing apparatus on which they are being executed to perform said method feature.

### BRIEF DESCRIPTION OF THE DRAWINGS

Preferred features of the present invention will now be described, purely by way of example, with reference to the accompanying drawings, in which:

FIG. 1 illustrates a data graph including conceptual and non-conceptual data;

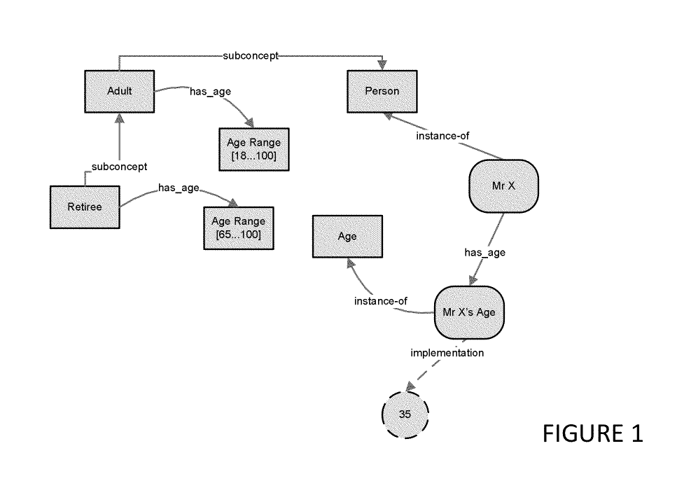

FIG. 2 illustrates a computing apparatus embodying the present invention;

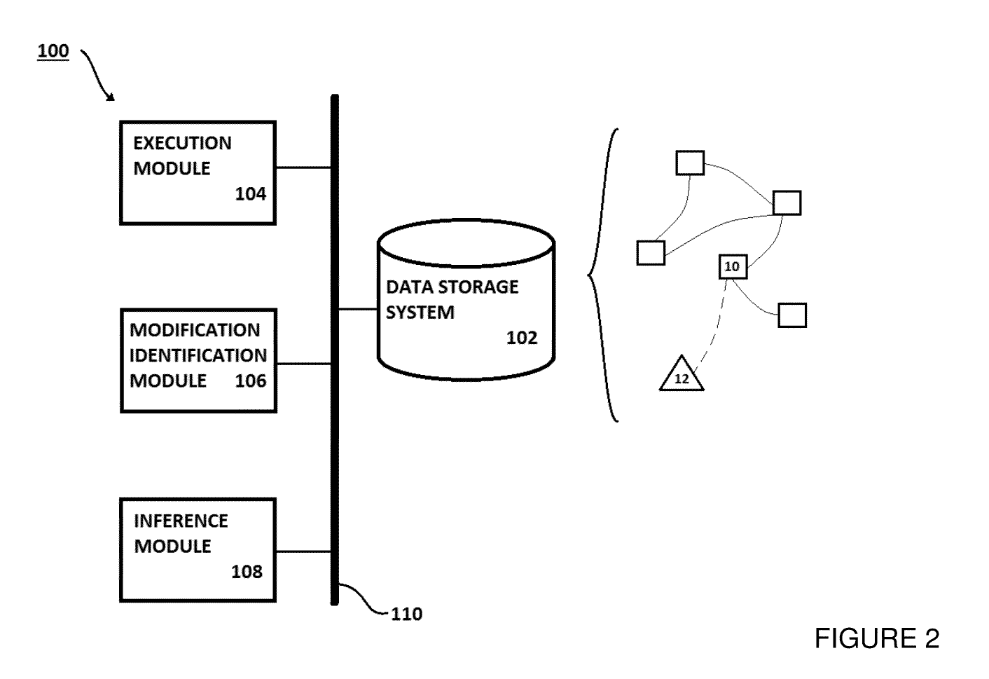

FIG. 3 illustrates an exemplary data graph and associated non-conceptual data items stored in a data storage system according to embodiments;

FIG. 4 is a flow chart representing the process of identifying modifications made to the graph as a consequence of a behavior handler procedure being executed and inferring relationships between behavior handlers; and

FIG. 5 is a diagram representing exemplary computing apparatus architecture of an embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

The computing apparatus 100 comprises a data storage system 102, an execution module 104, a modification identification module 106, and an inference module 108. A representation of data stored in the data storage system 102 is illustrated to the right hand side of the data storage system 102. The representation is illustrative of a region of a data graph and includes a behavior handler 10 as a graph node connected to other graph nodes, wherein the squares represent graph nodes and the curved lines connecting the squares represent graph edges. The dashed line represents an association and connects a non-conceptual data item 12 to the behavior handler 10 which utilizes the non-conceptual data item 12 in order to update the data graph.

The computing apparatus 100 is configured to automate the integration of non-conceptual data items 12 into a data graph, the data graph being composed of graph elements including graph nodes and graph edges.

The data storage system 102, the execution module 104, the modification identification module 106, and the inference module 108 may be referred to collectively as functional modules, and may be realized by hardware configured specifically for carrying out the functionality of the module. The functional modules may also be realized by instructions or executable program code which, when executed by a computer processing unit, cause the computer processing unit to perform the functionality attributed to the functional module. The computer processing unit may operate in collaboration with one or more of memory, storage, I/O devices, network interfaces, sensors (either via an operating system or otherwise), and other components of a computing device, in order to realize the functionality attributed to the functional module. The modules may also be referred to as units, and may be steps or stages of a method, program, or process.

The functional modules are configured to exchange data with one another via a communications network 110. The communications network 110 may include one or more of the following: wired or wireless connections between computing devices; one functional module storing data in a memory or storage where it is accessible to other functional modules.

The computing apparatus 100 may be realized by a single computing device or server, or may be realized by more than one computing device or server operating collaboratively, for example, as one or more layers of a control protocol. Therefore, each functional module may be executed by components belonging to a plurality of computing devices, and the functional modules may be provided by more than one computing device.

The data storage system 102 is configured to store, as a graph node of the data graph for each of a plurality of non-conceptual data items 12, a behavior handler 10 defining a procedure for using the non-conceptual data item 12 to update the data graph in response to an occurrence of a specified trigger event, the graph node representing the behavior handler 10 being stored in association with the non-conceptual data item 12. The data storage system 102 may also comprise one or more data management units configured to unify data distributed across more than one individual data storage unit and present a graph-wide representation of data accessible to client applications. The one or more data management units may also be configured to handle queries and to provide an interface for accessing the stored data graph.

The execution module 104 is configured to execute the procedure defined by a behavior handler 10 from among the behavior handlers in response to an occurrence of the specified trigger event for the behavior handler. The execution module 104 may be configured to maintain a register linking each behavior handler 10 to specified events so that when there is an occurrence of an event linked to a behavior handler 10 the execution module 104 is configured to execute the procedure defined by the behavior handler 10. The execution module 104 may also be configured to maintain a queue or some other system for determining when resources are available for executing a procedure and instructing the execution accordingly. The execution module 104 may be configured to access hardware including one or more computer processing units and memory in order to execute procedures. The execution module 104 may be configured to execute the procedures in such a way that the changes/modifications/updates made to the graph as a consequence of executing the procedure are recorded, for example in a system log.

The modification identification module 106 is configured to identify graph elements modified as a consequence of the execution of the procedure, and to record the identified graph elements as members of a set of modifications attributed to the behavior handler 10 defining the executed procedure. The set of modifications attributed to each behavior handler 10 may be stored and updated each time the procedure defined by the behavior handler is executed. The modification identification module 106 may be configured to read a system log on which graph updates are recorded and to link the graph updates to the execution of a particular procedure (for example, by pattern matching or by using information in the system log to determine which procedure was being executed whilst the updates occurred). The modification identification module 106 may be configured to compare the state of the data graph before and after execution of a procedure in order to determine the graph elements that were modified as a consequence of the procedure being executed. The modification identification module 106 may be configured to execute a graph edit distance algorithm in order to identify the graph elements updated as a consequence of the procedure being executed. The graph elements considered to be modified as a consequence of a procedure being executed may be restricted to those graph elements directly written to or updated by the procedure itself. Alternatively, it may be that one or more additional procedures triggered by graph updates performed by the procedure also modify graph elements, and that the graph elements so modified are also identified by the modification identification module 106 as being modified as a consequence of the procedure being executed.

The inference module 108 is configured to infer relationships between behavior handlers 10 by, for each pair of behavior handlers defining executed procedures, analyzing the sets of modifications attributed to the pair of behavior handlers in order to identify relationships between the sets of modifications, and adding the identified relationships to the data graph as edges between the graph nodes representing the respective behavior handlers 10. For any or each pair of behavior handlers from among the plurality of behavior handlers, the inference module 108 is configured to compare the sets of modifications attributed to the respective behavior handlers, and, based on patterns or relationships identified which apply to the membership of one set of modifications in relation to the membership of the other set of modifications, to determine how the two behavior handlers are related.

The inference module 108 may be configured to apply each of a predetermined set of rules to the two sets of modifications being analyzed, and if the two sets adhere to the rule, to determine that a relationship being tested by the rule exists between the two sets. Such a relationship is then added to the data graph as a connection between the graph nodes representing the behavior handlers 10, and by association between the behavior handlers 10 and the respective non-conceptual data item 12, semantic information (the relationship) is linked to the non-conceptual data items 12 and they become part of the semantic knowledge being represented by the data graph and hence integrated.

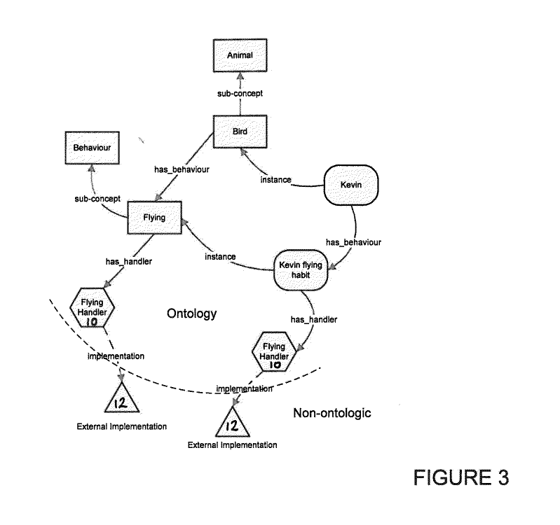

An exemplar snapshot of a data graph and associated non-conceptual data items stored by a data storage system 102 is illustrated in FIG. 3. Non-conceptual data 12 are stored and managed by behavior handlers 10 which encapsulate functionality with respect to the non-conceptual data.

Behavior is manifested in the ontological knowledge model through conceptual surrogate specifying the main characteristics of behavior by defining a procedure that is to be executed in response to an occurrence of a specified trigger event. The behavior handlers 10 are considered as semantic constraints and connected to data items through channeled ontological properties. FIG. 3 shows how the connection between behavior handlers 10 and data items is established at both class (left-hand side) and instance (right-hand side) levels. In FIG. 3, the rectangles represent classes (or concepts), the rounded rectangles represent instances, the hexagons represent the behavior handlers 10, and triangles are non-conceptual data items 12 which implement the behavior handlers 10, for example by reciting machine-readable code, and reside outside the ontology. The form of the non-conceptual data items 12 implementing the behavior handlers 10 may be, for example: code in a native programming language, processing instructions prompting user input, processing instructions configured to run in the absence of user input. Semantic information attributed to the behavior handlers 10 manifests itself when the implementation data items 12 interact with and modify the data graph. When the semantics are not manifested, they are considered unknown based on the open world assumption. In FIG. 3, flying data behavior is given at the concept level to all birds and at the instance level to “Kevin”. Even though the same external implementation is used in the given example, behavior handlers 10 can be realized differently based on specific application requirements.

The behavior handlers 10 are event-driven. Events which trigger the behavior handlers 10 are specified, for example, as properties of the data graph which apply to the behavior handlers 10 collectively, or as properties defined on a per-behavior handler basis. Events which trigger behavior handlers can be both system events and data events. System events correspond to system level operations and are normally used to trigger behaviors that are applicable to a large number of resources. Data events are triggered by data operations, e.g. data insertion, data visits, data update and removal, etc.

In case of data event, it may be that the scope of event determines which behavior handler is triggered. That is to say, different behavior handlers specify different event scopes that they are responsive to. For example, if a data event is a consequence of a data modification at the class level, the behavior handler 10 associated with class level data items in the data graph is triggered (if it specifies class-level events) and the procedure it defines is executed. On the other hand, if a data event is a consequence of a data modification at the instance level, the behavior handler 10 associated with instance level data items in the data graph is triggered (if it specifies instance-level events) and the procedure it defines is executed. Alternatively or additionally, it may be that a behavior handler 10 stored as a property of a class-level data item in the data graph specifies that the procedure it defines should be executed in response to both class-level and instance-level data events, with potential that instance level behavior overrides the concept level behavior.

Exemplary techniques used by the inference module 108 in order to infer relationships based on sets of modifications attributed to behavior handlers 10 will now be discussed. It may be that semantic information is defined explicitly by the behavior handler, and the inference module 10 is configured to extract the semantic information and apply it to the graph elements representing the behavior handler 10. Alternatively or additionally, the inference module 108 is configured to identify semantic information which manifests itself through the change of state of the data graph caused by the sets of modifications attributed to respective behavior handlers.

The following is exemplary of techniques which may be employed by the inference module 108:
1. Let Gᵢ be the graph before a specific behaviour handler 10 is triggered and the procedure it defines executed on the graph, and Gᵢ₊₁ be the graph after the procedure is terminated and the graph converges to a stable state. ΔG=Gᵢ₊₁−Gᵢ is defined as the difference between the two graphs that explicates the set of graph modifications that are attributable to the triggered behaviour handler. That is to say, ΔG_{b} is the set of modifications attributed to the behaviour handler b, its membership being modified graph elements.
2. Behaviour handler bᵢ is a first triggered behaviour handler and behaviour handler bⱼ is a second triggered behaviour handler (first and second are for distinction only and do not impart any technical significance to either behaviour handler).
3. A rule applied by the inference module 108 may be that behaviour handler b is subsumed by behaviour handler, bⱼ, if and only if ΔG_{b}_{ᵢ}>ΔG_{b}_{ᵢ}
4. Another rule applied by the inference module 108 may be that behaviour handler bⱼ is subsumed by behaviour handler bᵢ, if and only if ΔG_{b}_{ᵢ}>ΔG_{b}_{ⱼ} Another rule applied by the inference module 108 may be that behaviour handler is equivalent to behaviour handler bⱼ if and only if ΔG_{b}_{ⱼ}>ΔG_{b}_{ᵢ} and ΔG_{b}_{ⱼ}

Operator is defined as:
1. If ΔGᵢ⊂ΔGⱼ, then ΔGⱼ [symbol] ΔGᵢ
2. ΔGⱼ>ΔGᵢ, if for every vertex v∈ΔGᵢ one of the following rules holds:
   a. v is a sub-concept of an descendant of some vertex v″∈ΔGⱼ, i.e. v and v′ can be connected with “is-a” edges or “instance-of” edges,
   b. ∃w, (w x₀), (x₀ x₁) . . . (xₙv)∈Gᵢ, and ∃w′, (w′ x′₀), (x′₀ x′₁) . . . (x′ₘ v′)∈Gⱼ [symbol] w⊂w′ and xᵢ⊂x′₁ for all the interim concepts/vertices, i.e. if the two vertices cannot be connected with “is-a/instance-of” edges, they are the range of some properties who are connected with “is-a/instance-of” edges either in the different graph or in the original graph.
3. If ΔGⱼ is an isograph of ΔGᵢ, then ΔGⱼ>ΔGᵢ and ΔGᵢ>ΔGⱼ

The semantic explication can be progressive by updating the set of modifications attributed to a behavior handler 10 each time the behavior handler 10 is triggered. Therefore the progressive manifestation is defined as the extent scope of the behavior:

ε∈ₖ(b)=ε∈ₖ₋₁(b)∪ΔGₖ^{b}

where ΔGₖ^{b}=Gₖ(b)−Gₖ. In other words, the kth version of the set of modification attributable to behavior handler b, is the union of the (k−1)th manifestation and the difference between the resultant graph after b is triggered and the original graph before b is triggered for the kth time. ε represents the manifestation process.

The behavior handlers 10 may be configured so that graph updates resulting from their execution (or the execution of the procedures which they define) are localized to the graph nodes connected to the graph node representing the behavior handler 10, or to remote (i.e. not connected to the graph node representing the behavior handler by an edge) regions of the graph defined in the behavior handler. Each behavior handler 10 may be configured to maintain a list of changes made to the state of the graph, for instance in a system log file. When such log files are not available, a graph edit distance algorithm can be used to: identify what changes have been made to the graph; and isolate the graph elements that have been updated. The above-detailed inference rules can then be used to compare the sets of modifications attributed to pairs of behavior handlers from among the plurality of behavior handlers in order to determine how the behavior handlers are related and which semantic information representing those relationships should be added to the data graph.

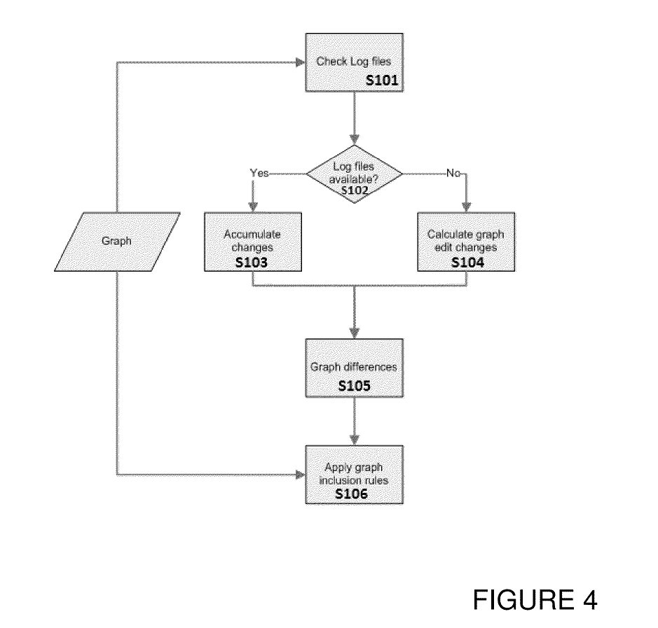

FIG. 4 is a flow chart representing the process of identifying modifications made to the graph as a consequence of a behavior handler procedure being executed and inferring relationships between behavior handlers.

Steps S101 to S105 are exemplary of a process which may be performed by a modification identification module 106. Step S106 is exemplary of a process which may be performed by an inference module 108.

At Step S101 the system log files are checked. The system log files are a record of the updates made to the graph, and enable the updated graph elements to be identified. In addition, the system log files may include a timestamp attributed to each modification, and an identification of the behavior handler being executed causing the modification to be made.

At step S102 it is determined whether log files are available. It may be that the data graph is implemented in a manner in which system log files are not maintained, or are unavailable for some other reason.

If it is determined that the log files are not available at step S102, then the flow proceeds to S104, and the modifications made to the graph are calculated. For example, a graph edit distance algorithm may be executed in order to identify updated graph elements. The calculation of graph modifications may be restricted to particular regions of the graph which the behavior handler in question has the potential to influence. Such regions may be determined at design time and identified in the behavior handler or may be determined based on the content of the behavior handler. Snapshots of the state of the graph or regions thereof may be used as a basis for the calculations.

If it is determined that the log files are available at step S102, then the flow proceeds to step S103, and the modifications attributable to the execution of the procedure defined by the behavior handler are accumulated. The changes may be identified based on the timestamps in comparison with the time of execution of the procedure, based on the modified graph elements and their proximity to the graph node representing the behavior handler, and/or based on an explicit identification of the procedure giving rise to the modification. The system log file can be made available while the procedure defined by a behavior handler is executed. The difference calculation can be distributed and delegated to the behavior handler, which can be running on a different server in a distributed data system. This increases the parallelization of the graph difference calculation.

At step S105, the set of modifications attributed to a behavior handler are collated. This may be simply the result of steps S103 and/or S104, or may include a step of combining the most recent modifications attributable to the behavior handler with the set of modifications already attributed to the behavior handler. For example, each time the procedure defined by a behavior handler is executed, any graph elements modified by the procedure that had not already been included in the set of modifications attributed to the behavior handler are added to the set of modifications.

At step S106, the sets of modifications attributed to pairs of behavior handlers are compared using, for example, the rules set out above. Relationships between sets of modifications are identified and added to the graph as properties of the graph nodes representing the behavior handlers. The selection of pairs may be, for example, the most recently triggered behavior handler with each other behavior handler in the graph. Alternatively, the rules may be applied on an occasional basis, for example, when processing capacity allows, and a log maintained of each set of modifications that has been updated since it was last compared with the other sets of modifications. The sets of modifications identified in the log may then be compared with each other set of modifications.

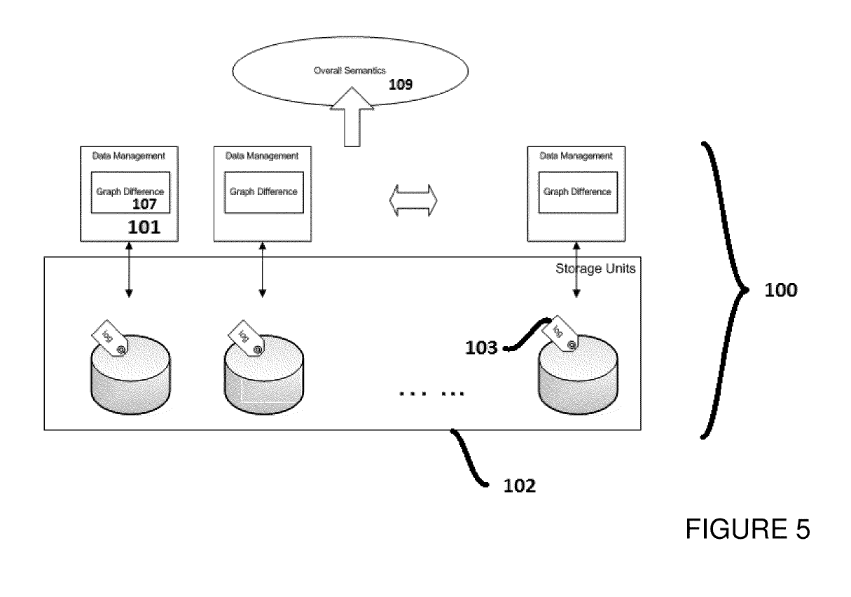

FIG. 5 illustrates an exemplary architecture of a computing apparatus embodying the present invention. The data storage system 102 comprises a plurality of storage units. Each storage unit maintains a system log 103 and has a data management component 101 which is configured to identify modifications 107 made to the sub-graph stored on the storage unit as a consequence of a procedure defined by a behavior handler 10 being executed. The data management components 101 are configured to cooperate to aggregate the individual modifications 107 in order to establish a set of modifications attributable to the behavior handler 10 from which semantic information 109 can be determined by comparison with sets of modifications attributable to other behavior handlers.

In any of the above aspects, the various features may be implemented in hardware, or as software modules running on one or more processors. Features of one aspect may be applied to any of the other aspects.

The invention also provides a computer program or a computer program product for carrying out any of the methods described herein, and a computer readable medium having stored thereon a program for carrying out any of the methods described herein. A computer program embodying the invention may be stored on a computer-readable medium, or it could, for example, be in the form of a signal such as a downloadable data signal provided from an Internet website, or it could be in any other form.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A computing apparatus configured to automate integration of non-conceptual data items into a data graph, the data graph comprising graph elements including graph nodes and graph edges, the computing apparatus comprising:
a data storage system configured to store, as a graph node of the data graph for each of a plurality of non-conceptual data items, a behavior handler defining a procedure for using a non-conceptual data item to update the data graph in response to an occurrence of a specified trigger event, the graph node representing the behavior handler being stored in association with the non-conceptual data item;
an execution module configured to execute the procedure defined by the behavior handler from among the behavior handlers in response to the occurrence of the specified trigger event for the behavior handler;
a modification identification module configured to identify graph elements modified as a consequence of execution of the procedure, and to record identified graph elements as members of a set of modifications attributed to the behavior handler defining the executed procedure; and
an inference module configured to infer relationships between behavior handlers by, for each pair of behavior handlers defining executed procedures, analyzing sets of modifications attributed to the pair of behavior handlers to identify relationships between the sets of modifications, and adding identified relationships to the data graph as edges between the graph nodes representing respective behavior handlers.

2. A computing apparatus according to claim 1, wherein relationships between behavior handlers the inference module is configured to infer comprise subsumption relationships.

3. A computing apparatus according to claim 2, wherein the inference module is configured to apply rules from a predetermined set of rules to the sets of modifications of each of a pair of behavior handlers to identify which relationships from among the predetermined set of relationships exist between the sets of modifications.

4. A computing apparatus according to claim 3, wherein the modification identification module is configured to store the set of modifications attributed to each of the behavior handlers and, each time the procedure defined by a behavior handler from among the plurality of behavior handlers is executed and the modified graph elements identified, the identified graph elements are recorded as members of the set of modifications attributed to the behavior handler by replacing a stored set of modifications attributed to the behavior handler by a union of the stored set and the identified graph elements.

5. A computing apparatus according to claim 4, wherein executing the procedure defined by a behavior handler includes:
adding a record to a log stored in association with the behavior handler each time a graph element is modified by the procedure; and
the modification identification module being configured to identify graph elements modified as a consequence of the execution of the procedure by reading the log stored in association with the behavior handler defining the procedure.

6. A computing apparatus according to claim 5, wherein the modification identification module is configured to identify graph elements modified as a consequence of the execution of the procedure by executing a graph edit distance algorithm.

7. A computing apparatus according to claim 6, wherein the data graph is a conceptual data graph.

8. A computing apparatus according to claim 7, wherein the conceptual data graph is encoded using an ontology modeling language.

9. A computing apparatus according to claim 8, wherein the non-conceptual data items are encoded by a schema system.

10. A computing apparatus according to claim 9, wherein the specified trigger event is one of a structural change to a specified sub-graph within the data graph and a modification to the non-conceptual data item.

11. A computing apparatus according to claim 10, wherein the computing apparatus is a plurality of servers connected via a communication network, each server being configured to store a sub-graph of the data graph.

12. A computing apparatus according to claim 11, wherein, the modification identification module comprises a component module on each server configured to identify graph elements stored on a respective server modified as a consequence of the procedure.

13. A method for automated integration of non-conceptual data items into a data graph, the data graph comprising graph elements including graph nodes and graph edges, the method comprising:
for each of a plurality of non-conceptual data items:
representing, as a graph node of the data graph, a behavior handler defining a procedure for using a non-conceptual data item to update the data graph in response to an occurrence of a specified trigger event, the graph node representing a behavior handler being stored in association with the non-conceptual data item;
executing the procedure defined by the behavior handler in response to the occurrence of the specified trigger event; and
identifying graph elements modified as a consequence of execution of the procedure, and recording identified graph elements as members of a set of modifications attributed to the behavior handler defining the executed procedure;
the method further comprising:
inferring relationships between behavior handlers by, for each pair of behavior handlers, analyzing respective sets of modifications to identify relationships between the sets of modifications, and adding identified relationships to the data graph as edges between the graph nodes representing respective behavior handlers.

14. A computer program stored on a non-transitory computer readable medium which, when executed by a computing apparatus having a processor and a memory, causes the computing apparatus to perform a method for automated integration of non-conceptual data items into a data graph, the data graph comprising graph elements including graph nodes and graph edges, the method comprising:
for each of a plurality of non-conceptual data items:
representing, as a graph node of the data graph, a behavior handler defining a procedure for using the non-conceptual data item to update the data graph in response to an occurrence of a specified trigger event, the graph node representing a behavior handler being stored in association with the non-conceptual data item;
executing the procedure defined by the behavior handler in response to an occurrence of the specified trigger event; and
identifying graph elements modified as a consequence of the execution of the procedure, and recording identified graph elements as members of a set of modifications attributed to the behavior handler defining the executed procedure;
the method further comprising:
inferring relationships between behavior handlers by, for each pair of behavior handlers, analyzing respective sets of modifications identify relationships between the sets of modifications, and adding identified relationships to the data graph as edges between the graph nodes representing respective behavior handlers.

15. A suite of computer programs each stored on a non-transitory computer-readable medium and which, when executed by a plurality of computing devices each having a processor and a memory, cause the plurality of computing devices to function as a plurality of servers connected via a communication network, each server being configured to store a sub-graph of a data graph, the plurality of servers being configured to automate integration of non-conceptual data items into the data graph, the data graph comprising graph elements including graph nodes and graph edges, the plurality of servers being configured to perform a method comprising:
for each of a plurality of non-conceptual data items:
representing, as a graph node of the data graph, a behavior handler defining a procedure for using the non-conceptual data item to update the data graph in response to an occurrence of a specified trigger event, the graph node representing the behavior handler being stored in association with the non-conceptual data item;
executing the procedure defined by the behavior handler in response to the occurrence of the specified trigger event; and
identifying graph elements modified as a consequence of the execution of the procedure, and recording identified graph elements as members of a set of modifications attributed to a behavior handler defining the executed procedure;
the method further comprising:
inferring relationships between behavior handlers by, for each pair of behavior handlers, analyzing respective sets of modifications to identify relationships between the sets of modifications, and adding identified relationships to the data graph as edges between the graph nodes representing respective behavior handlers.
